(19) United States
(12) Patent Application Publication
(10) Pub. No.: US 2022/0130270 A1
(43) Pub. Date: Apr. 28, 2022

(54) GRADING SUPPORT DEVICE, GRADING SUPPORT SYSTEM, AND GRADING SUPPORT METHOD

(71) Applicant: NEC corporation, Minato-ku, Tokyo (JP)

(72) Inventors: Tetsuya KATAOKA, Tokyo (JP); Kenichi EMURA, Tokyo (JP)

(73) Assignee: NEC corporation, Minato-ku, Tokyo (JP)

(21) Appl. No.: 17/430,546

(22) PCT Filed: Feb. 10, 2020
(86) PCT No.: PCT/JP2020/005019

§ 371 Date: Aug. 12, 2021

(30) Foreign Application Priority Data
Feb. 15, 2019 (JP) 2019-025181

(51) Int. Cl. G09B 7/02; G06V 10/22

(52) U.S. Cl. CPC G09B 7/02; G09B 19/025; G06V 10/22

(57) ABSTRACT

To reduce the burden on the grader while minimizing variations in grading, a grading support device 30 comprises: an acquisition unit 31; an extraction unit 32; and a grading unit 33. The acquisition unit 31 acquires an answer file that includes information associated with the answer to a question. The extraction unit 32 extracts the answer from the answer file acquired. The grading unit 33 grades the extracted answer using learning results obtained through machine learning of the relationship between the answer and the grading results.

### TECHNICAL FIELD

The present invention relates to a technique for supporting work of grading answers to questions such as an examination.

### BACKGROUND ART

PTL 1 discloses the following technique as a technique for supporting grading. First, image data of an answered answer sheet is generated by a scanner. Then, the image data of a plurality of the answered answer sheets is collected, and answer fields are extracted from the collected image data. Moreover, an answer collection obtained by collecting the same answer fields from a plurality of the extracted answer fields is generated and printed out. The printed answer collection is graded by a grader. After that, the graded answer collection of paper is scanned to generate image data, and information of a grading result such as o or x is recognized from the image data. Image data of the graded answer sheet for each answerer is generated using the recognized information of the grading result, and the graded answer sheet is printed out and returned to the answerer.

### CITATION LIST

### Patent Literature

[PTL 1] JP 2018-37832 A

### SUMMARY OF INVENTION

### Technical Problem

In a case where graders such as teachers grade answers of an examination conducted in a school or the like, for example, there is a concern that a grading variation occurs in which a grading result varies depending on the grader although the answer is similar. Furthermore, there is a concern that a grading variation similar to the above occurs while the same grader grades the answers of a large number of answerers. Even in the technique of the grading support as described in PTL 1, there is a possibility that a grading variation occurs because a person grades an answer.

When the grading variation as described above occurs, the fairness of evaluation regarding the answerer cannot be maintained, and thus the grader is required to perform grading work while taking care not to cause the grading variation. As a result, the grader takes time and effort to adjust his/her awareness with other graders, review the graded grading result, and the like, in consideration of suppressing the grading variation in the grading work, and a burden on the grader regarding the grading work is large.

The present invention has been devised in order to solve the above problems. That is, a principal object of the present invention is to provide a technique capable of suppressing a grading variation and reducing a burden on a grader.

### Solution to Problem

To achieve the above object, a grading support device according to the present invention includes:

an acquisition unit configured to acquire an answered file including information of an answer to a question;

an extraction unit configured to extract the answer from the acquired answered file; and

a grading unit configured to grade the extracted answer using a learning result obtained through machine learning of a relationship between an answer and a grading result of the answer.

Furthermore, a grading support system according to the present invention includes:

a grading device configured to grade an answer to a question using a learning result obtained through machine learning of a relationship between an answer to the question and a grading result of the answer; and

a grading support device connected to the grading device,

in which

the grading support device includes

an acquisition unit configured to acquire an answered file including information of an answer to the question,

an extraction unit configured to extract the answer from the acquired answered file, and

a grading unit configured to grade the answer by outputting the extracted answer toward the grading device that grades the extracted answer.

Moreover, a grading support method according to the present invention includes:

acquiring an answered file including information of an answer to a question;

extracting the answer from the acquired answered file; and

grading the extracted answer using a learning result obtained through machine learning of a relationship between an answer and a grading result of the answer.

Moreover, a program recording medium according to the present invention records a computer program for causing a computer to execute:

processing of acquiring an answered file including information of an answer to a question;

processing of extracting the answer from the acquired answered file; and

processing of grading the extracted answer using a learning result obtained through machine learning of a relationship between an answer and a grading result of the answer.

### Advantageous Effects of Invention

According to the present invention, the grading variation can be suppressed, and the burden on a grader can be reduced.

### BRIEF DESCRIPTION OF DRAWINGS

FIG. 1 is a diagram for describing a configuration of a grading support system including a grading support device according to a first example embodiment of the present invention.

FIG. 2 is a block diagram for describing an example of a hardware configuration of a computer device constituting the grading support device.

FIG. 3 is a block diagram for describing a functional configuration of the grading support device of the first example embodiment.

FIG. 4 is a diagram for describing an example of a screen for registration used in a process of registering information.

FIG. 5 is a diagram illustrating an example of an answer sheet.

FIG. 6 is a diagram for describing an example of work in the process of registering information.

FIG. 7 is a diagram for describing another example of work in the process of registering information.

FIG. 8 is a block diagram for describing a further function of the grading support device.

FIG. 9 is a diagram illustrating an example of a screen used when checking information extracted by the grading support device.

FIG. 10 is a diagram schematically illustrating an operation of grouping extracted information.

FIG. 11 is a diagram illustrating an example of an answer.

FIG. 12 is a diagram illustrating an example of a case where answers to the same question are displayed side by side.

FIG. 13 is a diagram illustrating an example of an answer screen to which a grading result is added.

FIG. 14 is a flowchart illustrating an example of a grading support operation of the grading support device.

FIG. 15 is a diagram for describing a grading support system of a second example embodiment.

FIG. 16 is a diagram for describing a grading support system of a third example embodiment.

FIG. 17 is a diagram for describing a grading support device of another example embodiment.

FIG. 18 is a diagram for describing a grading support system of another example embodiment.

### EXAMPLE EMBODIMENT

Hereinafter, example embodiments according to the present invention will be described with reference to the drawings.

### First Example Embodiment

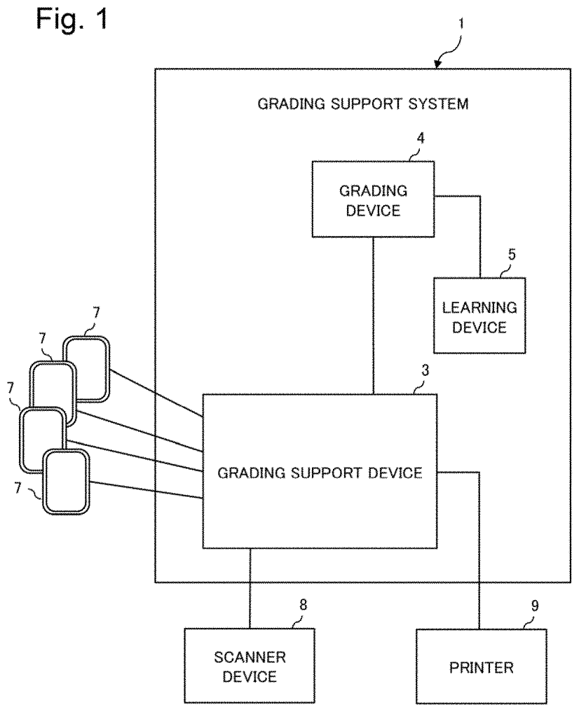

FIG. 1 is a block diagram illustrating a schematic configuration of a grading support system including a grading support device according to a first example embodiment of the present invention together with devices such as a printer connected to the system. A grading support system 1 according to the first example embodiment is a system that supports grading of answers to questions of an examination conducted at a school and an examination related to acquisition of a qualification. The grading support system 1 includes a grading support device 3, a grading device 4, and a learning device 5.

The learning device 5 has a function to perform machine learning of a relationship between an answer to a question and grading for the answer (a correctness/incorrectness determination result, a score according to sentence content as the answer, or the like) using data including relationship data between the answer to the question and a grading result for the answer as training data. There are various methods as a method of machine learning, and the method of machine learning adopted by the learning device 5 is appropriately set in consideration of a type of the answer (for example, an answer to a calculation formula, an answer to a multiple-choice question, an answer to a descriptive question, or an answer including a figure) and a data mode of the answer (for example, an image or a text (character information)).

The grading device 4 is connected to the grading support device 3, and has a function to grade an answer to be graded using a learning result of the machine learning by the learning device 5 in a case of receiving information of an answer to be graded from the grading support device 3.

Each of the grading device 4 and the learning device 5 is implemented by a computer device. More specifically, the grading device 4 and the learning device 5 are implemented by a processor such as a central processing unit (CPU) or a graphics processing unit (GPU).

The grading support device 3 is configured by a computer device. The grading support device 3 is connected to an information device 7, a scanner device 8, and a printer 9 via an information communication network such as the Internet, a local area network (LAN) or the like, or directly connected without via the information communication network.

The information device 7 is a computer device such as a tablet terminal or a personal computer operated by an answerer to answer an examination. The information device 7 has a function to perform display control of a display device by a built-in processor so as to present a question to the answerer of the examination and a function to receive information of an answer by the answerer. The information device 7 further has a function to generate and transmit an answered file including the received information of an answer and answerer identification information such as a name and an examination number for identifying the answerer as follows.

For example, there is a case where the information device 7 is a tablet terminal, and the answerer answers to a question by handwriting input using a touch panel provided in the tablet terminal. In this case, the information device 7 generates an image in which the handwritten information is superimposed on an image representing the question as an image of an answer screen. At this time, in a case where the answerer inputs the answerer identification information such as the name and the examination number by handwriting through the touch panel, the answerer identification information is also included in the image of the answer screen as a part of the image. Furthermore, a case is conceivable in which the answerer answers to the question using the information device 7 when the information device 7 acquires the answerer identification information and after from a server that executes authentication processing, for example. In this case, the acquired answerer identification information may be additional information attached to the image of the answer screen.

Moreover, the answered file is generated including examination identification information such as a title of the examination for identifying the examination that is the base of the answer and an examination type number representing examination content in the image of the answer screen as a part of the image of the answer screen or as additional information of the image of the answer screen. The answered file thus generated is transmitted from the information device 7 to the grading support device 3.

The scanner device 8 has a function to generate an image of an answer sheet by scanning the answer sheet and a function to transmit the image. In the first example embodiment, it is assumed that an entry field for the answerer to enter the answerer identification information such as the name and the examination number is described, and the examination identification information such as the examination title and examination type number for identifying the examination that is the base of the answer is described on the answer sheet. As a result, the image for answer transmitted from the scanner device 8 includes the answerer identification information and the examination identification information as a part of the image.

The printer 9 has a function to print out printing data received from a connected device such as the grading support device 3 on a paper sheet. A multifunction peripheral having both the function of the scanner device 8 and the function of the printer 9 may be connected to the grading support device 3 via an information communication network 100 or directly instead of the scanner device 8 and the printer 9.

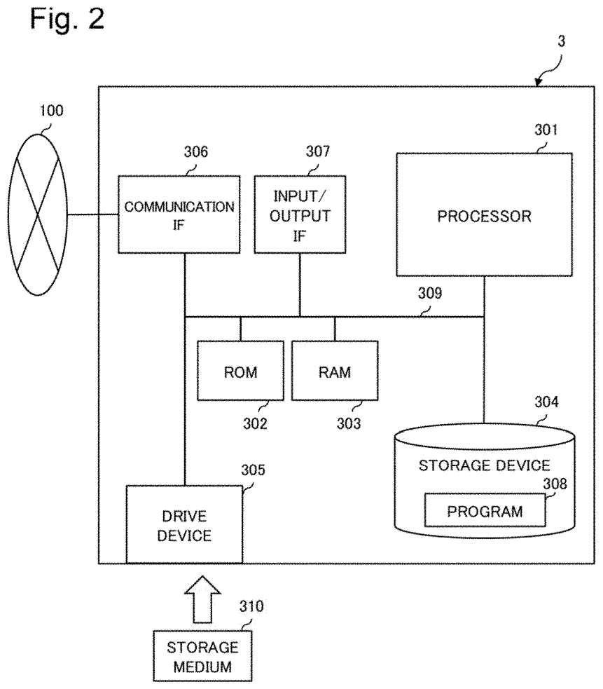

FIG. 2 is a block diagram for describing an example of a hardware configuration of a computer device that implements the grading support device 3. The grading support device 3 includes a processor 301 such as a central processing unit (CPU), a read only memory (ROM) 302, a random access memory (RAM) 303, a storage device 304 such as a hard disk device, and a drive device 305. The grading support device 3 further includes a communication interface (IF) 306 and an input/output interface (IF) 307.

The communication IF 306 has an interface function to exchange information with an external device via the information communication network 100. The input/output IF 307 has an interface function to directly exchange information with a peripheral device (an input device such as a keyboard, a mouse, or a touch panel, a display device, or the like) without via the information communication network 100.

The ROM 302, the RAM 303, and the storage device 304 are storage media for storing a computer program (hereinafter also abbreviated as program) and data. The drive device 305 has a function to read the program and data stored in a portable storage medium 310, for example, and to store the read program and data in the storage device 304 or the like. FIG. 2 illustrates one ROM 302, one RAM 303, and one storage device 304, but the numbers thereof are not limited and may be plural.

A program 308 and data stored in the storage medium such as the storage device 304 may be acquired from an outside via the information communication network 100 and the communication IF 306 or may be acquired by the drive device 305 from the portable storage medium 310 storing the program 308. As described above, the method of storing the program 308 and data in the storage medium such as the storage device 304 is not limited.

For example, the processor 301 has a configuration capable of having a function corresponding to the content of the program 308 by executing, for example, the program 308 stored in the storage device 304 using the RAM 303.

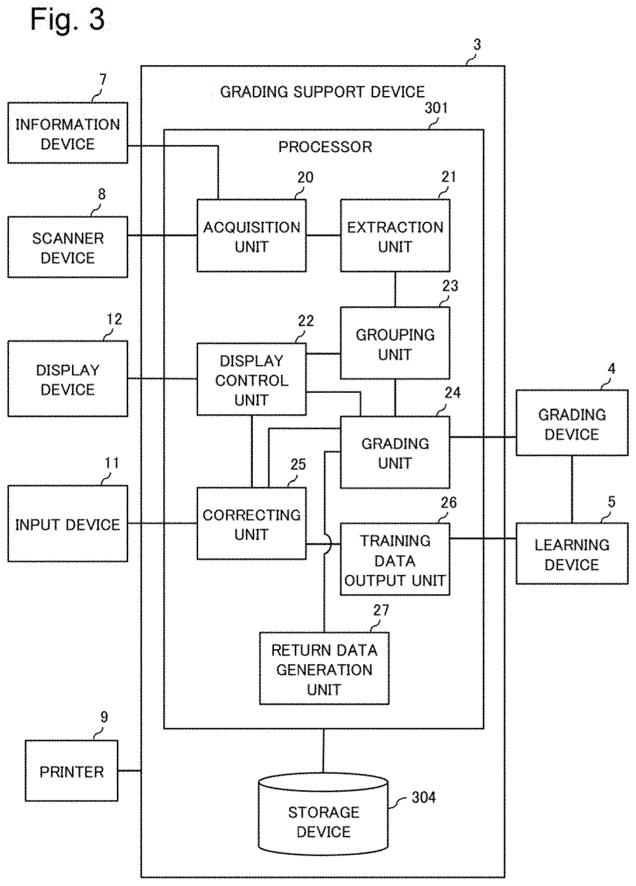

FIG. 3 is a block diagram for describing a functional configuration of the grading support device 3 of the first example embodiment. The grading support device 3 is connected to an input device 11 and a display device 12 in a data communicable state by the input/output IF 307. The input device 11 is a device that inputs information according to user's operation to the grading support device 3, and is configured by, for example, a keyboard, a mouse, a touch panel, or the like. The display device 12 includes a display device that displays an image.

The grading support device 3 has a function represented as a functional unit in FIG. 3 by the processor 301. That is, the processor 301 of the grading support device 3 includes an acquisition unit 20, an extraction unit 21, a display control unit 22, a grouping unit 23, a grading unit 24, a correcting unit 25, a training data output unit 26, and a return data generation unit 27.

The display control unit 22 has a function to control image display operation of the display device 12.

The acquisition unit 20 has a function to acquire the answered file including the information of an answer to a question. In the first example embodiment, a case in which the answerer answers to the question using the information device 7 and a case in which the answerer answers to the question on the answer sheet by handwriting are assumed. As a result, the acquisition unit 20 has a function to acquire the answered file transmitted from the information device 7 and a function to acquire the image of the answer sheet generated and transmitted by the scanner device 8 as the answered file. Furthermore, the acquisition unit 20 has a function to store the acquired answered file in the storage medium such as the storage device 304 or the RAM 303. In the following description, the ROM 302, the RAM 303, and the storage device 304 may be collectively referred to simply as storage media.

The extraction unit 21 has a function to extract predetermined information to be extracted from the answered file. In the first example embodiment, the information to be extracted includes the information of an answer, and the examination identification information and the answerer identification information to be associated with the information of an answer.

Since the information of an answer is included in the image in the answered file, the extraction unit 21 extracts the information of an answer from the image in the answered file as follows. In the case where the examination identification information and the answerer identification information are included in a part of the image in the answered file, the extraction unit 21 extracts the examination identification information and the answerer identification information from the image of the answered file, similarly to the extraction of the information of an answer. Since the method of extracting the examination identification information and the answerer identification information in this case is similar to the extraction of the information of an answer, description is omitted.

For example, information indicating a position of information to be extracted in the image of the answered file is stored in advance as extraction region information in the storage medium provided in the grading support device 3. The extraction unit 21 extracts the information to be extracted from the image of the answered file using the extraction region information.

Here, an example of the extraction region information and a registration process thereof will be described. As an example, the extraction region information is information in which extraction position information indicating the position of the information to be extracted in the image of the answer sheet by the scanner device 8 or the image of the answer screen by the information device 7 and extraction identification information for identifying the information to be extracted are associated with the examination identification information.

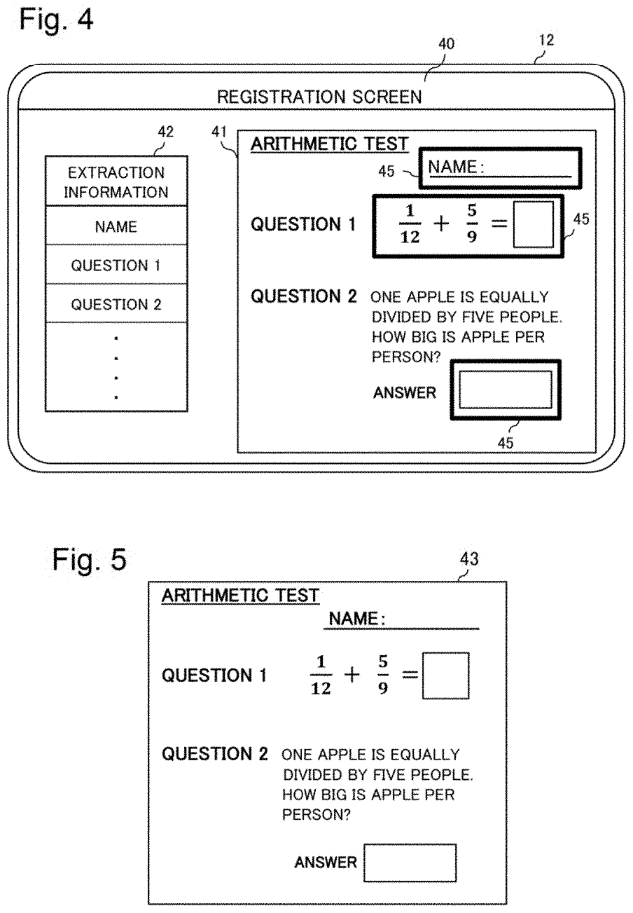

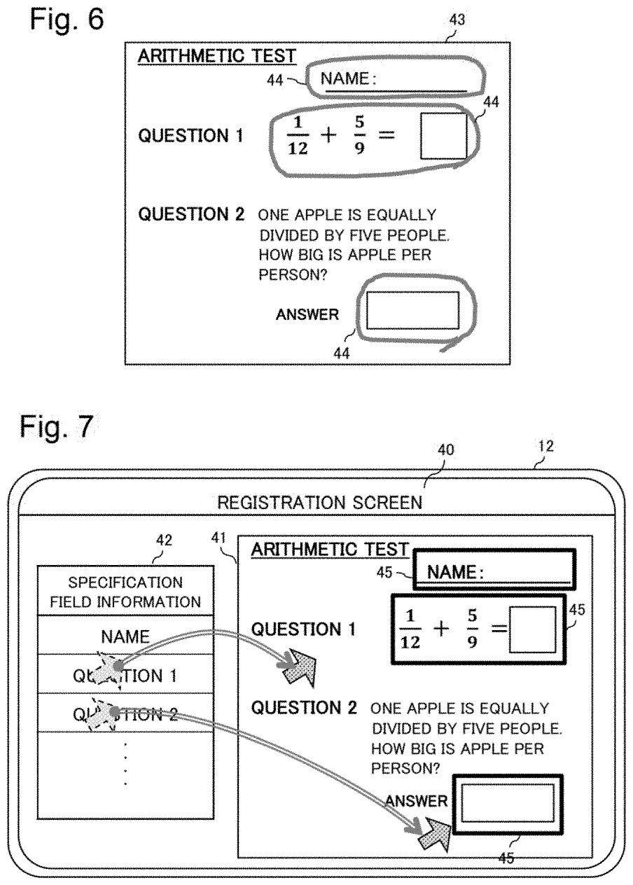

FIG. 4 is a diagram illustrating an example of a display screen of the display device 12 used in the process in which the extraction region information is registered in the grading support device 3 by the user. On a screen 40 of the display device 12 illustrated in FIG. 4, an extraction position specifying region 41 and an identification information specifying region 42 are set. In the process of registering the extraction region information, for example, a mark representing the position of the information to be extracted is written by handwriting on an answer sheet 43 as illustrated in FIG. 5 according to a predetermined rule. In the example of FIG. 6, a line surrounding the information to be extracted with a pen of a specified color (for example, green) is written on the answer sheet 43 as a mark 44 for extracting information. Such an image of the answer sheet 43 is generated by the scanner device 8 and transmitted to the grading support device 3. When receiving such an image of the answer sheet 43, the processor 301 of the grading support device 3 detects the position of the information to be extracted using the mark 44 in the image. Furthermore, the processor 301 of the grading support device 3 displays an image of the received answer sheet 43 in the extraction position specifying region 41 on the screen 40 of the display device 12 by a control operation of the display control unit 22 as illustrated in FIG. 4.

Moreover, the processor 301 of the grading support device 3 displays a frame (line) 45 according to a detection result of the position of the information to be extracted on the image of the extraction position specifying region 41 in an overlapping manner.

Meanwhile, in a case where the grading support device 3 can execute a function based on a sentence creation program or a drawing program, the user such as a question creator can generate an image for answer including an answer field by using the function of the grading support device 3. In a case where the image for answer is generated by the grading support device 3 or another computer device, as described above, the image for answer to which the mark representing the position of the information to be extracted is added is generated by the computer device such as the grading support device 3 according to a predetermined rule. Then, similarly to the above, the grading support device 3 detects the position of the information to be extracted from the image for answer, and displays the image for answer and displays the frame 45 according to the detection result on the image in an overlapping manner in the extraction position specifying region 41 on the screen 40 of the display device 12.

A display mode indicating the position of the information to be extracted in the extraction position specifying region 41 on the screen 40 is not limited to the frame 45 in the example of FIG. 4, and is appropriately set in consideration of the presence or absence of a question sentence (that is, whether both the question and the answer field are included or only the answer field is included) in the answer sheet or the image for answer, a layout of the answer field, and the like.

Moreover, the grading support device 3 displays the extraction identification information in the identification information specifying region 42 on the screen 40 of the display device 12 by display control of the display control unit 22. The extraction identification information identifies the information to be extracted included in the answer sheet or the image for answer displayed in the extraction position specifying region 41. For example, the extraction identification information is the title (question 1, question 2, or the like) of the question that is the base of the answer in a case where the information to be extracted is the information of an answer, or is an item name such as the name in a case where the information to be extracted is the name. Such extraction identification information is input to the grading support device 3 by the user operating the input device 11, for example.

Moreover, a rule of association operation as illustrated in FIG. 7 by the user is determined in advance, for associating the extraction identification information displayed in the identification information specifying region 42 on the screen 40 with the information to be extracted in the image of the extraction position specifying region 41. For example, as the rule of association operation, a rule to specify the extraction identification information in the identification information specifying region 42 on the screen 40 followed by the frame 45 representing the position of the information to be extracted that is to be associated with the specified extraction identification information in the extraction position specifying region 41 is determined.

When detecting that the user has performed an operation according to the rule of association operation on the screen 40 for registration according to operation information of the input device 11, the grading support device 3 associates the extraction position information indicating the position of the information to be extracted specified by the operation with the extraction identification information. Moreover, the grading support device 3 generates the extraction region information by associating the examination identification information with the extraction position information and the extraction identification information, and stores the generated extraction region information in the storage medium.

The extraction unit 21 reads the extraction region information as described above from the storage medium, and extracts an image region determined by the extraction region information from the image of the answered file. An image of the extracted image region (hereinafter also referred to as an extracted image) is associated with the extraction identification information included in the extraction region information as identification information.

Moreover, there are some cases where the extracted image may include an extracted image including the examination identification information or an extracted image including the answerer identification information. In this case, the extraction unit 21 further recognizes, in the extracted image, character information of the examination identification information or the answerer identification information indicating the information to be extracted by a technique of optical character recognition (OCR). Furthermore, if necessary, the extraction unit 21 may recognize character information indicating the information of an answer from the extracted image including the information of an answer similarly to the above.

In a case where the examination identification information or the answerer identification information is not an image but is included in the answered file as additional information of an image, the extraction unit 21 has a function to extract the examination identification information or the answerer identification information from the additional information of the answered file.

Moreover, the extraction unit 21 associates not only the extraction identification information but also the examination identification information and the answerer identification information extracted as described above with the extracted image including the information of an answer or the character information indicating the information of an answer. Information in which the extraction identification information, the examination identification information, and the answerer identification information are associated with the information of an answer in this manner is stored in the storage medium.

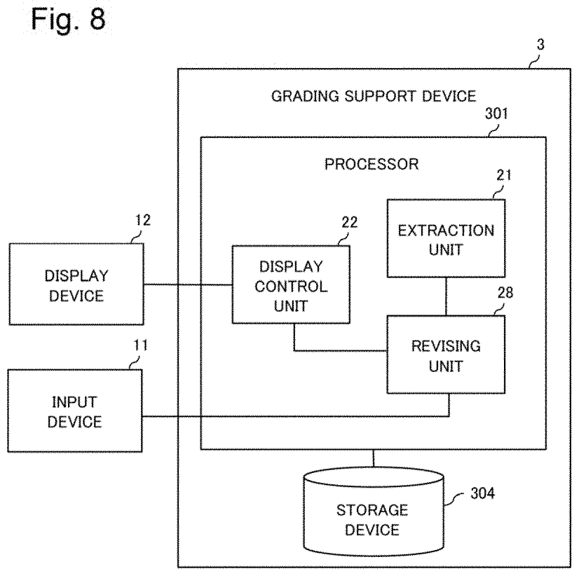

Meanwhile, there is a concern that a recognition error of a character occurs in the case where the character information of the answerer identification information (for example, the name) is recognized from the image of the answered file by the OCR technique. In consideration of this concern, for example, the processor 301 may include a revising unit 28 as illustrated in FIG. 8. The revising unit 28 has a function to enable correction of the character information of the answerer identification information extracted (recognized) from the answered file by the extraction unit 21.

In the case where the revising unit 28 is provided, for example, the character information indicating the answerer identification information is associated with the examination identification information in advance and stored in the storage medium as reference information. The revising unit 28 collates the character information of the answerer identification information recognized by the extraction unit 21 with the character information of the answerer identification information as the reference information. At this time, the revising unit 28 collates the recognized character information of the answerer identification information with the character information of the answerer identification information of the reference information associated with the same examination identification information as the examination identification information associated with the recognized character information.

Moreover, as a result of the collation, in a case where character information matching the recognized character information of the answerer identification information (for example, the character information of the name) is included in the reference information, the revising unit 28 determines that the recognized character information of the answerer identification information is correct. Furthermore, as a result of the collation, in a case where character information matching the recognized character information of the answerer identification information is not included in the reference information, the revising unit 28 determines that the recognized character information of the answerer identification information is incorrect.

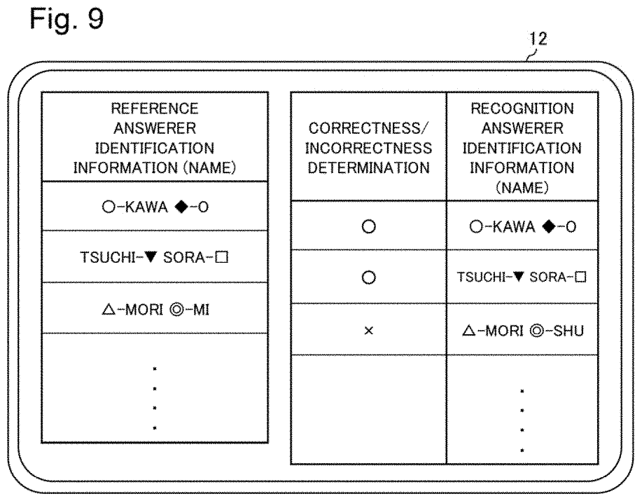

Moreover, as illustrated in FIG. 9, the revising unit 28 causes the display control unit 22 to display the recognized character information of the answerer identification information, a result of the correctness/incorrectness determination, and the answerer identification information as the reference information on the same screen of the display device 12. Moreover, the revising unit 28 causes the display control unit 22 to display a message or the like prompting the user to check the recognized character information of the answerer identification information on the display device 12 together with such a display. Moreover, in a case where information of correction (change) is input by an operation of the input device 11, the revising unit 28 revises (changes) the character information of the answerer identification information recognized by the extraction unit 21 and stored in the storage medium according to the input information.

For example, the revising unit 28 may receive information for correcting the character information of the answerer identification information of the reference information using the operation information of the input device 11, and correct the character information of the answerer identification information of the reference information stored in the storage medium according to the information.

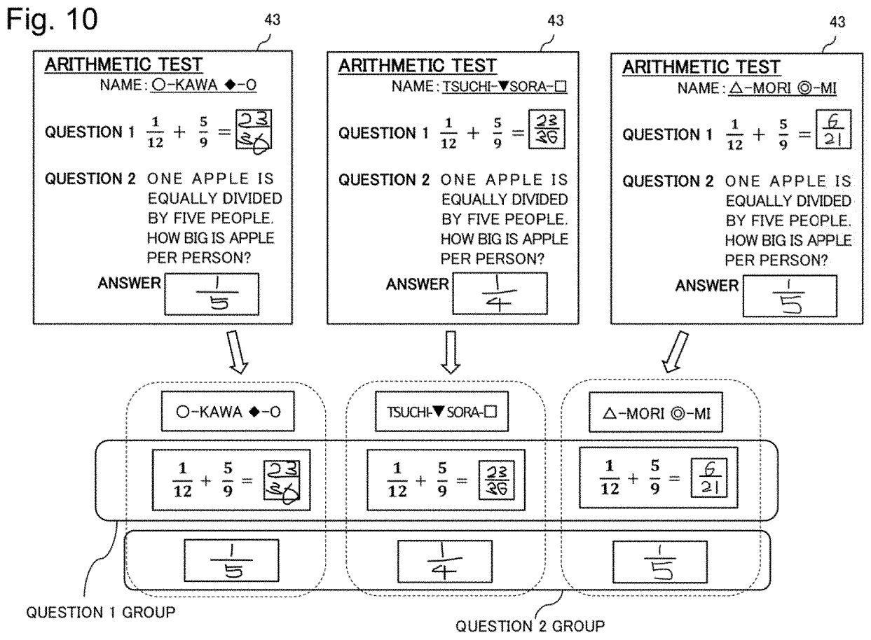

In a case where a plurality of answered files including the same examination identification information is acquired, the grouping unit 23 illustrated in FIG. 3 groups the extracted images including the information of an answer to the same question extracted from the answered files, using the extraction identification information. FIG. 10 is a diagram schematically illustrating the function of the grouping unit 23. In other words, the grouping unit 23 assigns group identification information indicating the same group to the extracted images including the information of an answer to the same question. In the case where the character information indicating the information of an answer is extracted (recognized) by the extraction unit 21, the grouping unit 23 groups pieces of the character information including the information of an answer to the same question similarly to the above.

The grading unit 24 illustrated in FIG. 3 has a function to transmit the extracted image including the information of an answer extracted by the extraction unit 21 or the character information indicating the information of an answer to the grading device 4 as the information of an answer to be graded. In other words, the grading unit 24 has a function to grade an answer using the grading device 4 by transmitting the information of an answer to be graded to the grading device 4. The information of an answer to be graded transmitted from the grading unit 24 to the grading device 4 is associated with the examination identification information and the extraction identification information. The timing at which the grading unit 24 transmits the information of an answer to be graded to the grading device 4 may be timing at which the user requests transmission using the input device 11 or timing of a transmission time set in advance, and is not particularly limited. Furthermore, the information to be graded may be transmitted to the grading device 4 in units of groups using the group identification information by the grouping unit 23.

Here, a specific example of a grading function by the grading device 4 will be described.

For example, the learning device 5 generates grading data (grading model) for each question in advance by machine learning using an image including a model answer and an image including an incorrect answer as training data. Then, the grading data (grading model) to which the examination identification information (such as the title of the examination) and the extraction identification information (such as the title and number of the question) are assigned is provided from the learning device 5 to the grading device 4.

When receiving the extracted image including the information of an answer to be graded, the grading device 4 grades the answer included in the image to be graded using the grading data (grading model) according to the examination identification information and the extraction identification information associated with the image.

In the case of grading the answer in the state of the image as described above, the grading device 4 can also perform the following grading. For example, as illustrated in FIG. 11, in a case where the answer of a calculated value of a mathematical expression is correct but a character (number) representing the calculated value deviates from a frame 47 representing a region where the answer is to be written, grading of giving a score obtained by deducting points from a score given to the correct answer becomes possible. In the case where such grading is performed, machine learning by the learning device 5 in consideration of such grading is executed, and grading data (grading model) by the machine learning is used by the grading device 4.

Furthermore, the grading device 4 can grade a descriptive answer of writing a sentence. In this case, as described above, the extraction unit 21 extracts the information of an answer not only as the information of an image but also as the character information. Furthermore, the grading unit 24 transmits the information of an answer to be graded to the grading device 4 in the form of character information. Furthermore, the learning device 5 generates grading data (grading model) obtained through machine learning using a descriptive model answer as training data, and assigns the examination identification information and the extraction identification information to the generated grading data (grading model) and provides the generated data to the grading device 4. When receiving the information of an answer to be graded based on the character information, the grading device 4 analyzes the sentence of the answer by, for example, a syntax analysis or the like, and calculates a similarity between the answer and the grading data (grading model) according to the examination identification information and the extraction identification information associated with the answer. Moreover, the grading device 4 sets a score determined according to the similarity as a grading result of the answer.

The grading result by the grading device 4 is returned to the grading unit 24 in a mode in which the examination identification information and the extraction identification information are associated with each other. The grading unit 24 has a function to store the information of an answer to be graded having the same information as the examination identification information and the extraction identification information associated with the grading result in a storage medium in association with the grading result as a graded file when receiving the grading result. Moreover, in a case where a plurality of graded files having the same examination identification information and answerer identification information and having different extraction identification information is stored in the storage medium, the grading unit 24 reads information of the grading results included in the graded files. Then, the grading unit 24 executes an operation of calculating a score of the answerer by summing scores of all the questions and an operation of determining pass/fail using the read information of the grading results.

By the grading unit 24 grading the answer using the grading device 4 as described above, an effect of preventing a grading error and suppressing a grading variation can be obtained.

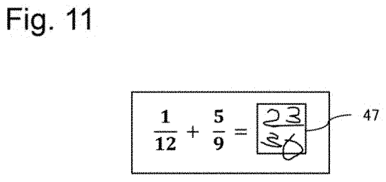

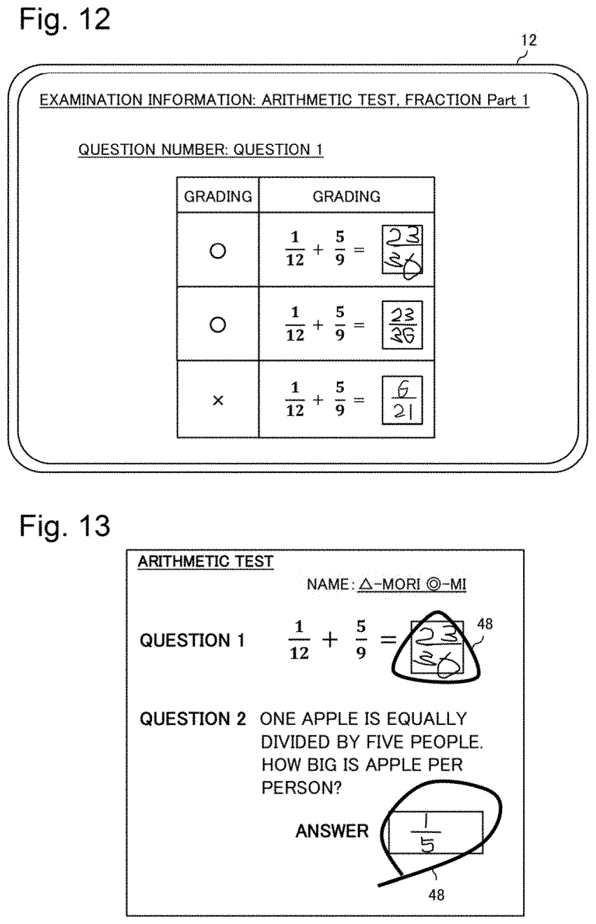

The correcting unit 25 has a function to receive correction information for correcting the grading result and correcting the grading result on the basis of the correction information. For example, in a case where the graded file is generated or a request of displaying the grading result by the user is detected, the correcting unit 25 reads the graded file including the grading result to be displayed from the storage medium using the information such as the examination identification information and the extraction identification information. Then, the correcting unit 25 causes the display device 12 to display the read information of an answer and the read grading result of the answer by the display control operation of the display control unit 22. In addition, the correcting unit 25 can display a plurality of answers to the same question and the grading results thereof next to each other on the same screen of the display device 12 as illustrated in FIG. 12 by the display control operation of the display control unit 22 using the group identification information by the grouping unit 23 in response to the request of the user. By displaying the grading results of the plurality of answers to the same question next to each other in this manner, the user such as a teacher can check while comparing the grading results of the plurality of answers to the same question on the same screen, for example. As a result, the check of the grading results considering the grading variation becomes easier than a case where the user checks the grading results in a state where the grading results of the plurality of answers to the same question are displayed on different screens. In particular, in a case where the answer is of a descriptive type of writing a sentence, occurrence of some grading variations is conceivable in the grading by the grading device 4 although the grading variations are suppressed by the grading device 4. In contrast, as described above, the grading results of the plurality of answers to the same question are displayed on the same screen by the correcting unit 25, whereby the user can easily check the grading results so as to further suppress the grading variations.

In a case where the user inputs information of a corrected grading result obtained by correcting the grading result displayed on the display device 12 to the grading support device 3, as the correction information, using the input device 11, the correcting unit 25 receives the correction information. Furthermore, the correcting unit 25 recognizes the grading result to be corrected using display control information of the display control unit 22 and the operation information of the input device 11, and changes the grading result in the graded file to be corrected stored in the storage medium to the corrected grading result based on the correction information.

The training data output unit 26 has a function to output information of the corrected grading result and predetermined information including the information of an answer associated with the grading result to the learning device 5 as training data in the case where the correcting unit 25 has corrected the grading result. The learning device 5 learns the relationship between the answer and the score thereof and the like using the training data received from the training data output unit 26.

The return data generation unit 27 has a function to generate an image of the answer sheet or an image of the answer screen to which information according to the grading result as illustrated in FIG. 13 (a mark 48 such as a circle, a triangle, or a cross according to the grading result) is added as return data. The image generating method of adding the grading result to the image of the answer sheet or the image of the answer screen is not particularly limited, and description thereof is omitted here. Furthermore, the timing of generating the return data may be any predetermined timing as long as the grading results are added to all the answered files having the same examination identification information and the same answerer identification information and the graded files are generated.

Moreover, the return data generation unit 27 may have a function to generate print data for printing the image of the answer sheet or the image of the answer screen to which the grading result is added on a paper sheet in response to a request given using the input device 11 or the like.

The return data generated by the return data generation unit 27 is transmitted to an information device possessed by the answerer via, for example, the information communication network. As a result, the answerer can view the grading result using the information device. Furthermore, the print data according to the return data is provided to the printer 9, and the answer sheet with the grading result printed out by the printer 9 is returned to the answerer.

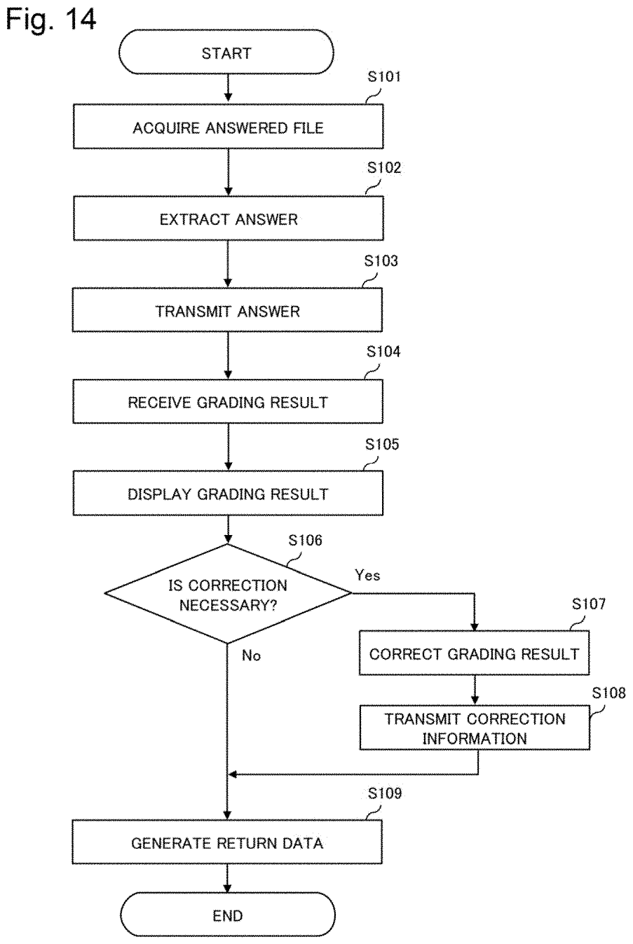

The grading support device 3 in the first example embodiment is configured as described above. An example of the operation of the grading support function in the grading support device 3 will be described below with reference to FIG. 14. FIG. 14 is a flowchart illustrating an example of the operation of the grading support function of the grading support device 3, and illustrates a control procedure executed by the processor 301.

For example, when the acquisition unit 20 acquires the answered file from the information device 7 or the scanner device 8 (step S101 in FIG. 14), the extraction unit 21 extracts the information to be extracted including the information of an answer included in the answered file (step S102). After that, the grading unit 24 transmits the answers to be graded extracted from the answered file to the grading device 4 in units of groups using, for example, the group identification information by the grouping unit 23 (step S103). Thereafter, when the grading unit 24 receives the grading result from the grading device 4 (step S104), the correcting unit 25 causes the display device 12 to display the grading result (step S105).

Furthermore, the correcting unit 25 determines whether the correction information for correcting the displayed grading result has been input (in other words, whether there is a correction) and corrects the grading result of the graded file according to the correction information (step S107) when there is a correction (Yes in step S106). Moreover, the training data output unit 26 transmits the information of the corrected grading result and the predetermined information including the information of an answer associated with the grading result to the learning device 5 as the training data (step S108).

After that, the return data generation unit 27 generates the return data (step S109). The generated return data is returned to the answerer at appropriate timing and by an appropriate return method. When the grading support device 3 communicates information with the information device 7, the scanner device 8, the printer 9, the grading device 4, or the like, security measures are taken for the information to be communicated.

In step S105, when the correcting unit 25 causes the display device 12 to display the grading result, in a case where the correction information for correcting the grading result is not input and there is no correction (No in step S106), the return data generation unit 27 generates the return data (step S109). The generated return data is returned to the answerer at appropriate timing and by an appropriate return method.

The grading support system 1 including the grading support device 3 of the first example embodiment is configured to grade an answer to a question by using the grading device 4 that grades the answer using the learning result obtained through machine learning of the model answer and the incorrect answer. As a result, the grading support device 3 and the grading support system 1 according to the first example embodiment do not require a person such as a teacher to perform grading, so that the burden on the grader such as a teacher can be reduced, and moreover, the grading variation can be suppressed as compared with a case where a person performs grading work.

Furthermore, the grading support device 3 includes the correcting unit 25, and has the function to cause the user such as a teacher to check the grading result by the grading device 4 and to cause the correcting unit 25 to correct (change) the grading result as necessary. As a result, the reliability of grading ability of the grading support system 1 and the grading support device 3 can be improved.

Furthermore, the grading support device 3 has the function to display the grading results of a plurality of answers to the same question next to each other on the display device 12 when causing the user to check the grading results by the grading device 4, thereby further suppressing the grading variation.

Moreover, the grading support device 3 has the function to provide the corrected grading result to the learning device 5 as the training data to use the training data in the machine learning by the learning device 5 in the case where the grading result by the grading device 4 has been corrected by the function of the correcting unit 25. As a result, the number and variation of training data used in the machine learning by the learning device 5 can be increased, and as a result, the reliability of the grading result by the grading device 4 can be enhanced.

Moreover, the grading support device 3 has the function to grade the answer assuming both a case where the answerer answers the question on the answer sheet and a case where the answerer answers the question using the information device 7. Furthermore, the grading support device 3 has the function to generate the print data for printing out the answer sheet to which the grading result is added and the function to generate the image of the answer screen to which the grading result is added. Therefore, for example, when the answerer answers to the question on the answer sheet, the grading support device 3 can present the grading result to the answerer by the return data including the image of the answer screen to which the grading result is added. Furthermore, the grading support device 3 can present the grading result to the answerer with the answer sheet to which the grading result is added when the answerer answers the question using the information device 7.

### Second Example Embodiment

Hereinafter, a second example embodiment according to the present invention will be described. In the description of the second example embodiment, the same reference numerals are given to the same name portions as the components constituting the grading support device and the grading support system of the first example embodiment, and redundant description of the common portions will be omitted.

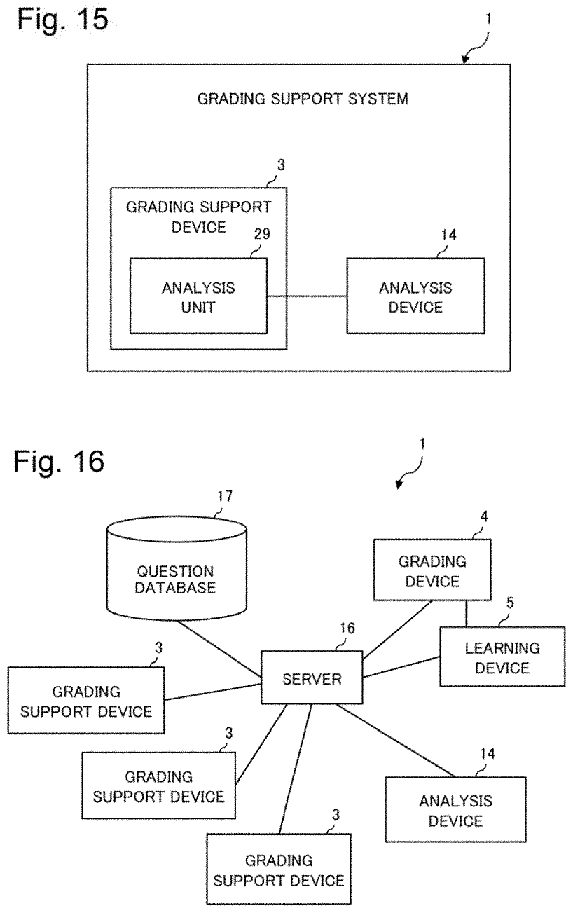

A grading support system 1 according to the second example embodiment includes an analysis device 14 illustrated in FIG. 15 in addition to the configuration of the grading support system 1 of the first example embodiment. Furthermore, a grading support device 3 includes an analysis unit 29 as a function of a processor 301. In FIG. 15, illustration of a grading device 4, a learning device 5, and the like constituting the grading support system 1 is omitted.

The analysis device 14 has a function to acquire a question, an answer to the question, and a grading result of the answer, and analyze the answer to the question by statistical processing. The method of the statistical processing executed by the analysis device 14 is appropriately set according to analysis content required by a user of the grading support system 1, and description thereof is omitted here.

The analysis unit 29 included in the grading support device 3 has a function to transmit information of the answer to be analyzed to the analysis device 14 in a case of detecting that an analysis request has been input to the grading support device 3 together with the information for specifying the answer to be analyzed by an operation of an input device 11, for example.

Furthermore, the analysis unit 29 has a function to acquire an analysis result from the analysis device 14 in a case of detecting that a command of requesting the analysis result has been input to the grading support device 3 by an operation of the input device 11, and cause a display control unit 22 to display the acquired analysis result on a display device 12.

Configurations of the grading support device 3 and the grading support system 1 of the second example embodiment other than the above configurations are similar to those of the first example embodiment.

The grading support system 1 of the second example embodiment has the function to analyze the grading result of the answer to the question in addition to the configuration of the first example embodiment. Since such an analysis result of the grading result can be used as a reference for creating a new question, the grading support system 1 can also support a question creator.

### Third Example Embodiment

Hereinafter, a third example embodiment according to the present invention will be described. In the description of the third example embodiment, the same reference numerals are given to the same name portions as the components constituting the grading support device and the grading support system of the first or second example embodiment, and redundant description of the common portions will be omitted.

A grading support system 1 of the third example embodiment includes a server 16 as illustrated in FIG. 16. The server 16 has a function to control connection among a plurality of types of devices related to grading of an examination in consideration of security measures.

In the example of FIG. 16, the server 16 has a function to connect a plurality of grading support devices 3 installed at different schools to a common grading device 4 and a common learning device 5, for example. As a result, for example, the grading support system 1 can increase the number of training data received by the learning device 5 by a function of training data output units 26 of the grading support devices 3, and as a result, the reliability of the grading result of the grading device 4 can be enhanced.

Furthermore, the server 16 may have a function to enable presentation of information such as the analysis result by the analysis device 14 to the plurality of grading support devices 3. Moreover, the grading support system 1 may include a question database 17 that stores information such as questions on an examination, answer examples of the questions, and an answer tendency according to an analysis result of the answers. The server 16 may have a function to control an access from the grading support device 3 to the question database 17. Moreover, in a case where the grading support device 3 has a sentence creating function and a drawing function, it is conceivable that a question creator creates an examination question using these functions. In such a case, information of the questions and its answers created by the plurality of grading support devices 3 are registered from the plurality of grading support devices 3 to the question database 17 via the server 16, so that it becomes easy to enrich the information amount and types of the questions stored in the question database 17. Moreover, the server 16 may control browsing of information registered in the question database 17. Furthermore, the server 16 may have a function to control connection between another system and the grading support device 3.

The grading support device 3 includes a functional unit for being connected to another device via the server 16. As the method of being connected (communicating) with another device via the server 16, an appropriate method may be adopted in consideration of the type of a device of a connection partner or the like, and the description thereof is omitted here.

The grading support system 1 of the third example embodiment has the configuration that enables the grading support device 3 to be connected to another device via the server 16. As a result, the grading support system 1 can enhance the convenience for the user.

### Other Example Embodiments

The present invention is not limited to the first to third example embodiments, and various example embodiments can be adopted. For example, the grading support device 3 includes the training data output unit 26. In contrast, for example, in a case where the training data output unit 26 is not necessary because it is assumed that the number of training data that can be provided from the grading support device 3 to the learning device 5 is not large enough to improve a result of machine learning or the like, the training data output unit 26 may be omitted.

Furthermore, in a case where it is assumed that the group identification information by the grouping unit 23 is not necessary in the grading support device 3, the grouping unit 23 may be omitted.

Moreover, the grading unit 24 has the function to grade the answer by transmitting information of the answer to the grading device 4. In addition to the function, the grading unit 24 may have a function to determine correctness/incorrectness by collating an answer of a multiple-choice question or a calculation question of a calculation formula, for which correctness/incorrectness is clear, with correct answer data given in advance in a storage medium.

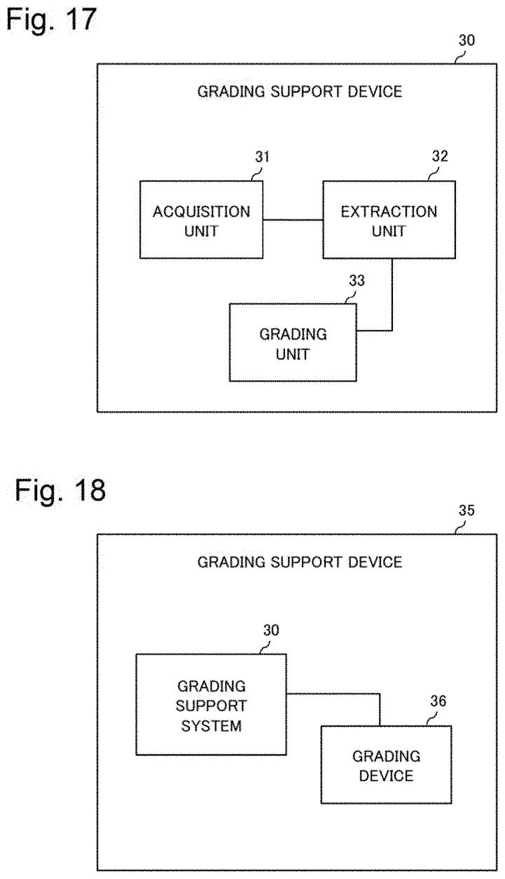

FIG. 17 is a diagram for describing another example embodiment according to the present invention. A grading support device 30 illustrated in FIG. 17 includes an acquisition unit 31, an extraction unit 32, and a grading unit 33. As illustrated in FIG. 18, the grading support device 30 constitutes a grading support system 35 together with a grading device 36 having a function to grade an answer to a question using a learning result obtained through machine learning of a relationship between an answer to a question and a grading result thereof.

The acquisition unit 31 of the grading support device 30 has a function to acquire an answered file including the information of an answer to a question. The extraction unit 32 has a function to extract the answer from the acquired answered file. The grading unit 33 has a function to grade the answer by transmitting the extracted answer to the grading device 36.

The grading support device 30 illustrated in FIG. 17 and the grading support system 35 illustrated in FIG. 18 have the above-described configuration, thereby obtaining the effect of suppressing the grading variation and reducing the burden on the grader.

Some or all of the above example embodiments can be described as but are not limited to the following supplementary notes.

(Supplementary Note 1)

A grading support device including:

an acquisition means for acquiring an answered file including information of an answer to a question;

an extraction means for extracting the answer from the acquired answered file; and

a grading means for grading the extracted answer using a learning result obtained through machine learning of a relationship between an answer and a grading result of the answer.

(Supplementary Note 2)

The grading support device according to supplementary note 1, in which, in a case where the information of an answer included in the answered file is displayed in a part of an image, the extraction means extracts a region where the information of an answer is displayed as the information of an answer from the image.

(Supplementary Note 3)

The grading support device according to supplementary note 1 or 2, further including: a correcting means for receiving correction information of the grading result from an outside and correcting the grading result based on the correction information.

(Supplementary Note 4)

The grading support device according to supplementary note 3, further including: a training data output means for outputting a corrected grading result based on the correction information as training data to be used for the machine learning.

(Supplementary Note 5)

The grading support device according to any one of supplementary notes 1 to 4, further including: a grouping means for grouping grading results of answers to a same question individually extracted from a plurality of the answered files acquired by the acquisition means.

(Supplementary Note 6)

A grading support system including:

a grading device configured to grade an answer to a question using a learning result obtained through machine learning of a relationship between an answer to the question and a grading result of the answer; and

a grading support device connected to the grading device,

in which

the grading support device includes

an acquisition means for acquiring an answered file including information of an answer to the question,

an extraction means for extracting the answer from the acquired answered file, and

a grading means for grading the answer by outputting the extracted answer toward the grading device that grades the extracted answer.

(Supplementary Note 7)

The grading support system according to supplementary note 6, further including:

a learning device configured to perform machine learning of the relationship between an answer to the question and a grading result of the answer, in which

the grading support device further includes

a correcting means for receiving correction information of the grading result from an outside and correcting the grading result based on the correction information, and

a training data output means for outputting a corrected grading result based on the correction information toward the learning device as training data to be used for the machine learning.

(Supplementary Note 8)

The grading support system according to supplementary note 6 or 7, further including: an analysis device configured to acquire the question, the answer to the question, and a grading result of the answer, and analyze the answer to the question by statistical processing.

(Supplementary Note 9)

A grading support method including:

acquiring an answered file including information of an answer to a question;

extracting the answer from the acquired answered file; and

grading the extracted answer using a learning result obtained through machine learning of a relationship between an answer and a grading result of the answer.

(Supplementary Note 10)

The grading support method according to supplementary note 9, further including: in a case where the information of an answer included in the answered file is displayed in a part of an image, extracting a region where the information of an answer is displayed as the information of an answer from the image.

(Supplementary Note 11)

The grading support method according to supplementary note 9 or 10, further including: receiving correction information of the grading result from an outside and correcting the grading result based on the correction information.

(Supplementary Note 12)

The grading support method according to supplementary note 11, further including: outputting a corrected grading result based on the correction information as training data to be used for the machine learning.

(Supplementary Note 13)

The grading support method according to supplementary note 11, further including: performing relearning using the corrected grading result based on the correction information as the training data to be used for the machine learning to update the learning result.

(Supplementary Note 14)

The grading support method according to any one of supplementary notes 9 to 13, further including: grouping grading results of answers to a same question individually extracted from a plurality of the acquired answered files.

(Supplementary Note 15)

The grading support method according to any one of supplementary notes 9 to 14, further including: analyzing the answer to the question by statistical processing based on the question, the answer to the question, and a grading result of the answer.

(Supplementary Note 16)

A program recording medium recording a computer program for causing a computer to execute:

processing of acquiring an answered file including information of an answer to a question;

processing of extracting the answer from the acquired answered file; and

processing of grading the extracted answer using a learning result obtained through machine learning of a relationship between an answer and a grading result of the answer.

(Supplementary Note 17)

The program recording medium according to supplementary note 16, recording a computer program for causing a computer to execute: in a case where the information of an answer included in the answered file is displayed in a part of an image, processing of extracting a region where the information of an answer is displayed as the information of an answer from the image.

(Supplementary Note 18)

The program recording medium according to supplementary note 16 or 17, recording a computer program for causing a computer to further execute: processing of receiving correction information of the grading result from an outside and correcting the grading result based on the correction information.

(Supplementary Note 19)

The program recording medium according to supplementary note 18, recording a computer program for causing a computer to further execute: processing of outputting a corrected grading result based on the correction information as training data to be used for the machine learning.

(Supplementary Note 20)

The program recording medium according to any one of supplementary notes 16 to 19, recording a computer program for causing a computer to further execute: processing of grouping grading results of answers to a same question individually extracted from a plurality of the acquired answered files.

The present invention has been described with reference to the above-described example embodiments as exemplary examples. However, the present invention is not limited to the above-described example embodiments. That is, various aspects that will be understood by those of ordinary skill in the art can be applied without departing from the scope of the present invention as defined by the claims.

This application is based upon and claims the benefit of priority from Japanese patent application No. 2019-25181, filed on Feb. 15, 2019, the disclosure of which is incorporated herein in its entirety by reference.

### REFERENCE SIGNS LIST

1, 35 Grading support system
3, 30 Grading support device
4, 36 Grading device
5 Learning device
14 Analysis device
16 Server
20, 31 Acquisition unit
21, 32 Extraction unit
24, 33 Grading unit
25 Correcting unit
26 Training data output unit
28 Revising unit

What is claimed is:

1. A grading support device comprising:
at least one memory storing instructions; and
at least one processor configured to access the at least one memory and execute the instructions to:
acquire an answered file including information of an answer to a question;
extract the answer from the acquired answered file; and
grade the extracted answer using a learning result obtained through machine learning of a relationship between an answer and a grading result of the answer.

2. The grading support device according to claim 1, wherein,
the at least one processor is further configured to execute the instructions to:
in a case where the information of an answer included in the answered file is displayed in a part of an image, extract a region where the information of an answer is displayed as the information of an answer from the image.

3. The grading support device according to claim 1, wherein
the at least one processor is further configured to execute the instructions to:
receive correction information of the grading result from an outside and correcting the grading result based on the correction information.

4. The grading support device according to claim 3, wherein
the at least one processor is further configured to execute the instructions to:
output a corrected grading result based on the correction information as training data to be used for the machine learning.

5. The grading support device according to claim 1, wherein
the at least one processor is further configured to execute the instructions to:
group grading results of answers to a same question individually extracted from a plurality of the answered files acquired by the acquisition means.

6. A grading support system comprising:
a grading device configured to grade an answer to a question using a learning result obtained through machine learning of a relationship between an answer to the question and a grading result of the answer; and
a grading support device connected to the grading device,
wherein
the grading support device includes
at least one memory storing instructions; and
at least one processor configured to access the at least one memory and execute the instructions to:
acquire an answered file including information of an answer to the question,
extract the answer from the acquired answered file, and
grade the answer by outputting the extracted answer toward the grading device that grades the extracted answer.

7. The grading support system according to claim 6, further comprising:
a learning device configured to perform machine learning of the relationship between an answer to the question and a grading result of the answer, wherein
the at least one processor of the grading support device is further configured to execute the instructions to:
receive correction information of the grading result from an outside and correcting the grading result based on the correction information, and
output a corrected grading result based on the correction information toward the learning device as training data to be used for the machine learning.

8. The grading support system according to claim 6, further comprising: an analysis device configured to acquire the question, the answer to the question, and a grading result of the answer, and analyze the answer to the question by statistical processing.

9. A grading support method comprising:
acquiring an answered file including information of an answer to a question;
extracting the answer from the acquired answered file; and
grading the extracted answer using a learning result obtained through machine learning of a relationship between an answer and a grading result of the answer.

10. The grading support method according to claim 9, further comprising:
in a case where the information of an answer included in the answered file is displayed in a part of an image, extracting a region where the information of an answer is displayed as the information of an answer from the image.

11. The grading support method according to claim 9, further comprising: receiving correction information of the grading result from an outside and correcting the grading result based on the correction information.

12. The grading support method according to claim 11, further comprising:
outputting a corrected grading result based on the correction information as training data to be used for the machine learning.

13. The grading support method according to claim 11, further comprising: performing relearning using the corrected grading result based on the correction information as the training data to be used for the machine learning to update the learning result.

14. The grading support method according to claim 9, further comprising:
grouping grading results of answers to a same question individually extracted from a plurality of the acquired answered files.

15. The grading support method according to claim 9, further comprising: analyzing the answer to the question by statistical processing based on the question, the answer to the question, and a grading result of the answer.

16-20. (canceled)
